(19) United States
(12) Patent Application Publication
(10) Pub. No.: US 2018/0298293 A1
(43) Pub. Date: Oct. 18, 2018

(54) Multifunctional Catalysts and Additives for Direct Biomass Conversion to Chemicals

(71) Applicant: Battelle Memorial Institute, Columbus, OH (US)

(72) Inventors: Zia Abdullah, Columbus, OH (US); Rachid Taha, Dublin, OH (US); Stephanie Flamberg, Plain City, OH (US); Michael A. O'Brian, Columbus, OH (US)

(21) Appl. No.: 15/521,254

(22) PCT Filed: Oct. 20, 2015
(86) PCT No.: PCT/US15/56388

§ 371 Date: Apr. 21, 2017

Related U.S. Application Data
(60) Provisional application No. 62/066,847, filed on Oct. 21, 2014.

(51) Int. Cl. C10L 1/02; B01J 29/40; C10B 53/02; C10B 57/18

(52) U.S. Cl. CPC C10L 1/02; B01J 29/40; C10L 2200/0469; C10B 57/18; C10L 2290/02; C10B 53/02

(57) ABSTRACT

Multifunctional catalysts are used to prepare modified bio-oils with improved characteristics. Bio-oil vapor phase, e.g., produced by pyrolysis of biomass, is contacted with a multifunctional catalyst. The multifunctional catalyst catalyzes a plurality of distinct reactions of the bio-oil vapor phase to produce a modified bio-oil.

### CROSS-REFERENCE TO RELATED APPLICATIONS

This application claims priority to U.S. Provisional Patent Application No. 62/066,847, filed on Oct. 21, 2014, which is entirely incorporated by reference herein.

### BACKGROUND

Fast pyrolysis of lignocellulosic biomass may yield 60-75% liquid bio-oil, with the potential to produce bio-fuels or valued chemicals, all from carbon-neutral, renewable sources. However, crude bio-oil may need to be modified before use as transportation fuel, e.g., because of low heating values, high corrosiveness, thermal instability, immiscibility with crude-oil-based fuels, and the like. These problems may be due to the presence of large amounts of water, organic acids, phenols, aldehydes, anhydrosugars, furan derivatives, and the like in crude bio-oil.

Bio-oil has been modified by physical processes. For example, light bio-oil has been emulsified in commercial fuel, but leading only to partial miscibility in the fuel. Further, this process may be energy intensive, may use expensive surfactants, and may use relatively large amounts of co-solvent, such as butanol.

Bio-oil by has been modified by chemical processes. For example, bio-oil may be upgraded via hydro-deoxygenation (HDO) on an acidic catalyst such as ZSM5 at 300° C.-800° C., where coke and tar formation may be fast. The HDO method may result in catalyst deactivation and reactor plugging, and may require high pressures and large quantities of hydrogen to remove the 35-50% oxygen typically present in bio-oil.

Bio-oil may be partially refined to combustible and stable oxygen-containing organic fuels, which may retain most or all of the bio-oil's original caloric value. For example, bio-oil may be upgraded by reaction with alcohols to convert reactive organic acids and aldehydes to esters and acetals, respectively, which may produce a stabilized bio-oil and water. However, excess alcohol and continuous water removal may be required. Reactive adsorption and reactive distilling have been used on bio-oil, but at an economically unattractive cost. Bio-oil may also be etherified and esterified with octene/butanol using an acid catalyst, a process which is attractive but expensive.

The present application appreciates that modification of bio-oil may be a challenging endeavor.

### SUMMARY

In one embodiment, a method is provided. The method may include providing a bio-oil vapor phase. The method may include contacting the bio-oil vapor phase with a multifunctional catalyst under conditions effective to catalyze a plurality of distinct reactions on the bio-oil vapor phase to produce a modified bio-oil in the vapor phase.

In another embodiment, a modified bio-oil is provided. The modified bio-oil may be a product of reaction of a bio-oil vapor phase in the presence of a multifunctional catalyst under conditions effective to catalyze a plurality of distinct reactions on the bio-oil vapor phase.

### BRIEF DESCRIPTION OF THE DRAWINGS

The accompanying figures, which are incorporated in and constitute a part of the specification, illustrate example methods and compositions, and are used merely to illustrate example embodiments.

FIG. 1 is a flow chart of a method 100 for forming a modified bio oil.

FIG. 2 is a table characterizing bio-oils prepared in EXAMPLES 1-3.

### DETAILED DESCRIPTION

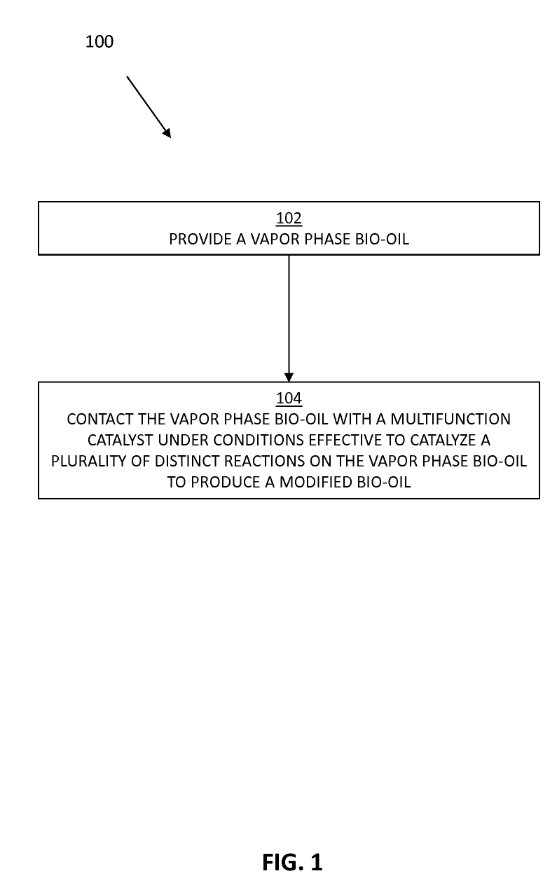

FIG. 1 is a flow chart of a method 100 for forming a modified bio oil. Method 100 may include 102 providing a bio-oil vapor phase. Method 100 may include contacting the bio-oil vapor phase with a multifunctional catalyst under conditions effective to catalyze a plurality of distinct reactions on the bio-oil vapor phase to produce the modified bio-oil in the vapor phase. For example, the contacting may include catalytically reacting the bio-oil vapor phase with the multifunctional catalyst in the plurality of distinct reactions on the bio-oil vapor phase to produce the modified bio-oil in the vapor phase. The contacting and catalytically reacting may be, e.g., a single step. In some embodiments, the plurality of distinct reactions may include one or more of: ketonization, esterification, etherification, isomerization, cracking reactions, deoxygenation, and the like.

In various embodiments, the method may include condensing the modified bio-oil from the vapor phase to produce the modified bio-oil in the liquid phase. The modified bio-oil may be characterized by a greater heating value compared to a liquid bio-oil condensed from the bio-oil vapor phase. For example, the modified bio-oil may be characterized by a heating value of at least about 20 MJ/mol. The heating value of the modified bio-oil may be characterized by a value in mega Joules per mol (MJ/mol) of about, or at least about one or more of: 18, 19, 20, 21, 22, 23, 24, 25, 26, 27, 28, 29, 30, 31, 32, 33, 34, 35, 36, 37, 38, 39, 40, 41, and 42, or in a range between any two of the preceding values, for example, between about 21 MJ/mol and about 31 MJ/mol.

In some embodiments, the modified bio-oil may be characterized by a lower total acid number (TAN) compared to a liquid bio-oil condensed from the bio-oil vapor phase. For example, the modified bio-oil may be characterized by a TAN of about, or less than about one or more of: 100, 95, 90, 85, 80, 75, 70, 65, 60, 55, 50, 45, 40, 35, 30, 25, 22, 20, 15, 10, and 5, or in a range between any two of the preceding values, for example, a TAN between about 20 and about 85.

In several embodiments, the modified bio-oil may be characterized by a lower oxygen content compared to a liquid bio-oil condensed from the bio-oil vapor phase. For example, the modified bio-oil may be characterized by an oxygen content in weight percent of about, or less than about one or more of: 45, 44, 43, 42, 41, 40, 39, 38, 37, 36, 35, 34, 33, 32, 31, 30, 29, 28, 27, 26, 25, 24.5, 24, 23, 22, 21, 20, 19, 18.5, 18, 17, 16, 15, 14, 13, 12, 11, 10, 9, 8, 7, 6, and 5, or in a range between any two of the preceding values, for example, oxygen content in weight percent of between about 18% and about 45% based on determining oxygen content in wet modified bio-oil, between about 14% and about 30% based on determining oxygen content in dry modified bio-oil, and the like. In another example, the modified bio-oil may be characterized by an oxygen content based on wet liquid phase modified bio-oil of less than about 45% by weight. The modified bio-oil may be characterized by an oxygen content based on wet liquid phase modified bio-oil of less than about 35% by weight. The modified bio-oil may be characterized by an oxygen content based on dry liquid phase modified bio-oil of less than about 35% by weight. The modified bio-oil may be characterized by an oxygen content based on dry liquid phase modified bio-oil of less than about 30% by weight.

In various embodiments, the modified bio-oil may be characterized compared to a liquid bio-oil condensed from the bio-oil vapor phase by a greater content of one or more of: ketones, aldols, esters, ethers, and saturated compounds. The modified bio-oil may be characterized compared to a liquid bio-oil condensed from the bio-oil vapor phase by a lower content of one or more radicals. The modified bio-oil may be characterized compared to a liquid bio-oil condensed from the bio-oil vapor phase by a higher average molecular weight. The modified bio-oil may be characterized compared to a liquid bio-oil condensed from the bio-oil vapor phase by a higher viscosity. The modified bio-oil may be characterized compared to a liquid bio-oil condensed from the bio-oil vapor phase by a higher hydrogen to carbon ratio.

In some embodiments, the bio-oil vapor phase may be at a pressure between about 1 atmospheres and about 35 atmospheres. For example, the bio-oil vapor phase may be at ambient pressure of about 1 atmosphere. The pressure may be absolute. In another example, the bio-oil vapor phase may be at a pressure of between about −10 in H₂O (−2.5 kPa) and about +10 in H₂O (+2.5 kPa). The bio-oil vapor phase may be at a temperature between about 300° C. and about 600° C. For example, the bio-oil vapor phase may be at a temperature between about 450° C. and about 500° C.

In several embodiments, the bio-oil vapor phase may include one or more radicals. As used herein, a radical is an organic compound that may include at least one unpaired electron in an open shell configuration. Such radicals may be more reactive compared to closed-shell compounds in the bio-oils described herein. At least one of the plurality of distinct reactions may be a catalyzed reaction of at least one of the one or more radicals. For example, at least one of the plurality of distinct reactions may include reacting at least one of the one or more radicals to form a closed-shell product compound. As used herein, a closed shell product compound may exclude unpaired electrons in open shell configurations. The electrons in the closed shell product compound may be paired in bonds, lone pairs, or other closed shell electron orbitals.

In various embodiments, providing the bio-oil vapor phase may include pyrolyzing a biomass. For example, the biomass may include a water content by weight of between about 0% and about 25%, e.g., between about 1% and about 25%, between about 10% and about 20%, and the like. The pyrolyzing the biomass may include heating the biomass at a heating rate effective to cause a vaporization in at least a portion of the biomass. The biomass may include one or more of: cellulose, hemicellulose, and lignin. The pyrolyzing the biomass may include chemical dehydration of one or more of: the cellulose, hemicellulose, and lignin. The pyrolyzing the biomass may include one or more of: chemical dehydration and decarboxylation to produce one or more radicals.

In some embodiments, the providing the bio-oil vapor phase may include pyrolyzing the biomass at a temperature in ° C. of about, or at least about one or more of: 400, 425, 450, 475, 500, 525, 550, 575, 600, 625, and 650, or a range between about any two of the preceding values. For example, the biomass may be pyrolyzed at a temperature between about 400° C. and about 600° C., a temperature between about 450° C. and about 500° C., and the like.

In several embodiments, the contacting the bio-oil vapor phase to the multifunctional catalyst may be conducted in the presence of one or more non-condensable compounds. For example, at least one of the plurality of distinct reactions may include reacting the bio-oil vapor phase with the one or more non-condensable compounds to produce the modified bio-oil in the vapor phase. In another example, at least one of the plurality of distinct reactions may include a coupling reaction with the one or more non-condensable compounds to produce a coupled compound fraction. For example, the one or more non-condensable compounds may be coupled to each other or to the bio-oil vapor phase to produce the coupled compound fraction. The coupled compound fraction may be condensable under conditions effective to condense the modified bio-oil from the vapor phase. For example, the modified bio-oil may include the coupled compound fraction. The one or more non-condensable compounds may include one or more of: carbon monoxide, carbon dioxide, hydrogen, and a C₁-C₆ hydrocarbon. The one or more non-condensable compounds may be prepared by pyrolyzing the biomass. For example, the one or more non-condensable compounds and the bio-oil vapor phase may both be prepared by pyrolyzing the biomass.

In various embodiments, contacting the bio-oil vapor phase to the multifunctional catalyst may be conducted in the presence of one or more hydrogen donor compounds. The one or more hydrogen donor compounds may react to donate hydrogen to radicals in the bio-oil vapor phase effective to increase a hydrogen to carbon ratio in the modified bio-oil in the vapor phase compared to the absence of the one or more hydrogen donor compounds. The one or more hydrogen donor compounds may include, for example, one or more of: methanol, ethanol, 1-propanol, 2-propanol, 1-butanol, 2-butanol, sec-butyl alcohol, tert-butyl alcohol, and ethylene glycol.

In some embodiments, providing the bio-oil vapor phase may include pyrolyzing a biomass. The providing and the contacting may be conducted together as a single step. For example, the contacting may include catalytically reacting the bio-oil vapor phase with the multifunctional catalyst in the plurality of distinct reactions on the bio-oil vapor phase to produce the modified bio-oil in the vapor phase. The contacting and catalytically reacting may be, e.g., a single step. The providing and the contacting may be conducted as two distinct steps, e.g., the providing followed stepwise by the contacting. In some embodiments, the contacting the bio-oil vapor phase to the multifunctional catalyst may be conducted in the presence of the one or more hydrogen donor compounds effective to increase a hydrogen to carbon ratio in the modified bio-oil compared to the absence of the one or more hydrogen donor compounds. Pyrolysis of the biomass may be conducted using one or more downflow or falling bed reactors, e.g., by pyrolyzing the biomass while falling through each downflow or falling bed reactor, for example, in the presence of a heat carrier. Example descriptions of downflow or falling bed reactors and pyrolysis of biomass therein, for example, in the presence of a heat carrier may be found in U.S. Prov. Pat. App. Ser. No. 61/826,989, filed May 23, 2013, the entire disclosure of which is incorporated herein by reference.

In some embodiments, the multifunctional catalyst may include two or more of: a basic catalyst, an acidic catalyst, a ketone-forming catalyst, an aldol-forming catalyst, an esterification catalyst, an etherification catalyst, and a cracking catalyst. For example, the multifunctional catalyst may include a transition metal oxide, e.g., TiO₂, RuTiO₂, Cr/TiO₂, Ru/TiO₂, Pd/NbOx, FCC catalyst, and the like. The multifunctional catalyst may include a zeolite, for example, Mg/Al₂O₃, WZrO, ZrO, TiO₂, ZSM5, SiO₂, and the like. The multifunctional catalyst may include a combination of a noble metal and one or more of: Cu, Ni, Co, Mo, Pt, Pd, Re, Ru, Rh, and the like. The multifunctional catalyst may include one or more of: Pt/MgAl₂O₃, Pt/Al₂O₃, Pd/ZSM5, Pd/Al₂O₃, and the like. The multifunctional catalyst may include, for example, one or more of: a fluid cracking catalyst and a hydrocracking catalyst. The method may include regenerating at least a portion of the multifunctional catalyst, for example, heating a fluid cracking catalyst in the presence of oxygen, e.g., in air.

In various embodiments, a modified bio-oil is provided. The modified bio-oil may be a product of reaction of a bio-oil vapor phase in the presence of a multifunctional catalyst under conditions effective to catalyze a plurality of distinct reactions on the bio-oil vapor phase. The modified bio-oil may be condensed from the modified bio-oil in the vapor phase.

In various embodiments, the modified bio-oil may be characterized by a greater heating value compared to a liquid bio-oil condensed from the bio-oil vapor phase, for example, a heating value of at least about 20 MJ/mol. The heating value of the modified bio-oil may be characterized by a value in mega Joules per mol (MJ/mol) of about, or at least about one or more of: 18, 19, 20, 21, 22, 23, 24, 25, 26, 27, 28, 29, 30, 31, 32, 33, 34, 35, 36, 37, 38, 39, 40, 41, and 42, or in a range between any two of the preceding values, for example, between about 21 MJ/mol and about 31 MJ/mol.

In some embodiments, the modified bio-oil may be characterized by a lower TAN compared to a liquid bio-oil condensed from the bio-oil vapor phase. For example, the modified bio-oil may be characterized by a TAN of about, or less than about one or more of: 100, 95, 90, 85, 80, 75, 70, 65, 60, 55, 50, 45, 40, 35, 30, 25, 22, 20, 15, 10, and 5, or in a range between any two of the preceding values, for example, a TAN between about 20 and about 85.

In several embodiments, the modified bio-oil may be characterized by a lower oxygen content compared to a liquid bio-oil condensed from the bio-oil vapor phase. For example, the modified bio-oil may be characterized by an oxygen content in weight percent of about, or less than about one or more of: 45, 44, 43, 42, 41, 40, 39, 38, 37, 36, 35, 34, 33, 32, 31, 30, 29, 28, 27, 26, 25, 24.5, 24, 23, 22, 21, 20, 19, 18.5, 18, 17, 16, 15, 14, 13, 12, 11, 10, 9, 8, 7, 6, and 5, or in a range between any two of the preceding values, for example, oxygen content in weight percent of between about 18% and about 41% based on determining oxygen content in wet modified bio-oil, between about 14% and about 30% based on determining oxygen content in dry modified bio-oil, and the like. In another example, the modified bio-oil may be characterized by an oxygen content based on wet liquid phase modified bio-oil of less than about 45% by weight. The modified bio-oil may be characterized by an oxygen content based on wet liquid phase modified bio-oil of less than about 35% by weight. The modified bio-oil may be characterized by an oxygen content based on dry liquid phase modified bio-oil of less than about 35% by weight. The modified bio-oil may be characterized by an oxygen content based on dry liquid phase modified bio-oil of less than about 30% by weight.

In various embodiments, the modified bio-oil may be characterized compared to a liquid bio-oil condensed from the bio-oil vapor phase by a greater content of one or more of: ketones, aldols, esters, ethers, and saturated compounds. The modified bio-oil may be characterized compared to a liquid bio-oil condensed from the bio-oil vapor phase by a lower content of one or more radicals. The modified bio-oil may be characterized compared to a liquid bio-oil condensed from the bio-oil vapor phase by a higher average molecular weight. The modified bio-oil may be characterized compared to a liquid bio-oil condensed from the bio-oil vapor phase by a higher hydrogen to carbon ratio. The modified bio-oil may be characterized compared to a liquid bio-oil condensed from the bio-oil vapor phase by a higher viscosity.

In some embodiments, the modified bio-oil may include a coupled compound fraction. The coupled compound fraction may be a reaction product of one or more non-condensable compounds. For example, the coupled compound fraction may be a reaction product of inter-reaction between the non-condensable compounds. The reaction product may be a product of the one or more non-condensable compounds and the bio-oil vapor phase. The one or more non-condensable compounds may include one or more of: carbon monoxide, hydrogen, and a C₁-C₆ hydrocarbon.

In several embodiments of the modified bio-oil, the bio-oil vapor phase may be provided by pyrolysis of biomass. The pyrolysis and the reaction may be conducted as a single step. The reaction may include catalytically reacting the bio-oil vapor phase with the multifunctional in the plurality of distinct reactions on the bio-oil vapor phase to produce the modified bio-oil in the vapor phase. The pyrolysis and the reaction may be conducted as two distinct steps. The reaction may be conducted in the presence of a hydrogen donor.

### EXAMPLES

### Example 1

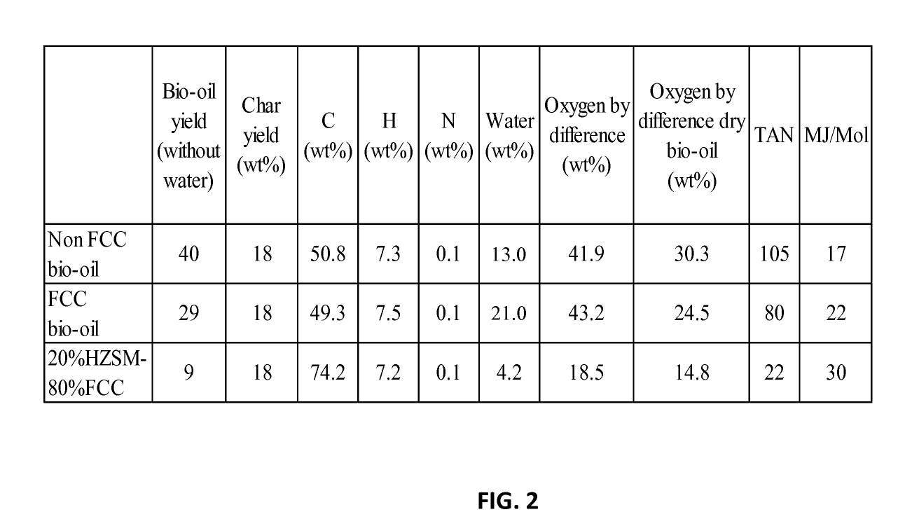

A laboratory scale pyrolysis reactor having a capacity of 50 lb/day (23 kg/day) was configured to produce bio-oil from biomass at temperatures between about 450° C. to about 550° C. Approximately 10 pounds (4.5 kg) of biomass (pine) was pyrolyzed at a feed rate of 1.5 to 2 pounds (0.45 kg to 1.1 kg) per hour at a temperature of 480° C. The biomass was pyrolyzed to produce a bio-oil vapor phase, char, aerosol particles, water, and non-condensable gases. No catalyst was employed. The bio-oil vapor phase was condensed to produce a liquid bio-oil. The Table in FIG. 2 shows the characteristics of the liquid bio-oil as “Non-Catalytic bio-oil.”

### Example 2

A laboratory scale pyrolysis reactor having a capacity of 50 lb/day (23 kg/day) was configured to produce bio-oil from biomass at temperatures between about 450° C. to about 550° C. Approximately 10 pounds (4.5 kg) of biomass (pine) was pyrolyzed at a feed rate of 1.5 to 2 pounds (0.45 kg to 1.1 kg) per hour at a temperature of 520° C. The biomass was pyrolyzed to produce a bio-oil vapor phase, char, aerosol particles, water, and non-condensable gases. The bio-oil vapor phase was passed over a spent fluid cracking catalyst (FCC), a mono-functional catalyst, to produce upgraded bio-oil vapor phase. The upgraded bio-oil vapor phase was condensed to produce an upgraded liquid bio-oil. The Table in FIG. 2 shows the characteristics of the upgraded liquid bio-oil as “FCC bio-oil.”

### Example 3

A laboratory scale pyrolysis reactor having a capacity of 50 lb/day (23 kg/day) was configured to produce bio-oil from biomass at temperatures between about 450° C. to about 550° C. Approximately 10 pounds (4.5 kg) of biomass (pine) was pyrolyzed at a feed rate of 1.5 to 2 pounds (0.45 kg to 1.1 kg) per hour at a temperature of 550° C. The biomass was pyrolyzed to produce a bio-oil vapor phase, char, aerosol particles, water, and non-condensable gases. The bio-oil vapor phase was passed over a multifunctional catalyst that included about 80% of a spent fluid cracking catalyst (FCC) and about 20% of an acidic zeolite, HZSM5. Passing the bio-oil vapor phase over the multifunctional catalyst at a temperature of 550° C. produced a modified bio-oil in the vapor phase. The modified bio-oil was condensed from the vapor phase to produce the modified bio-oil as a liquid. The Table in FIG. 2 shows the characteristics of the modified bio-oil as “20% HZSM5-80% FCC.”

The Table in FIG. 2 summarizes the characteristics of three bio-oils. The bio-oil quality was ranked in the following order: HZSM5-FCC>FCC>non-catalyst bio-oil. These results demonstrate that multifunctional catalysts lead to better bio-oil quality. The Table in FIG. 2 shows that the HZSM5-FCC bio-oil has fewer oxygenated compounds, lower acidity, and higher energy value compared to catalytic bio-oil produced from a mono-functional catalyst, FCC, and also compared to non-FCC bio-oil.

### Prophetic Example 4

A laboratory scale pyrolysis reactor having a capacity of 50 lb/day (23 kg/day) may be configured to produce bio-oil from biomass at temperatures between about 450° C. to about 550° C. Approximately 10 pounds (4.5 kg) of biomass (pine) may be pyrolyzed at a feed rate of 1.5 to 2 pounds (0.45 kg to 1.1 kg) per hour at a temperature of 550° C. The biomass may be pyrolyzed to produce a bio-oil vapor phase, char, aerosol particles, water, and non-condensable gases. The non-condensable gases may include hydrogen, carbon monoxide, carbon dioxide, and C₁-C₆ hydrocarbons. The bio-oil vapor phase may be passed over a multifunctional catalyst. The non-condensable gases may be captured and recirculated over the multifunctional catalyst, along with the bio-oil vapor phase at a temperature of 550° C. A modified bio-oil may be produced at the multifunctional catalyst in the vapor phase. The modified bio-oil in the vapor phase may be condensed to produce the modified bio-oil in the liquid phase. The modified bio-oil may include reaction products of both the bio-oil vapor phase and the non-condensable gases. For example, the modified bio-oil may include higher hydrocarbons derived at least in part from the non-condensable gases. The modified bio-oil may have improved properties compared to non-catalyzed bio-oil or bio-oil produced at a mono-functional catalyst, for example, higher heating value.

### Prophetic Example 5

A laboratory scale pyrolysis reactor having a capacity of 50 lb/day (23 kg/day) may be configured to produce bio-oil from biomass at temperatures between about 450° C. to about 550° C. Approximately 10 pounds (4.5 kg) of biomass (pine) may be pyrolyzed at a feed rate of 1.5 to 2 pounds (0.45 kg to 1.1 kg) per hour at a temperature of 550° C. The biomass may be pyrolyzed to produce a bio-oil vapor phase, char, aerosol particles, water, and non-condensable gases. The non-condensable gases may include hydrogen, carbon monoxide, carbon dioxide, and C₁-C₆ hydrocarbons. The bio-oil vapor phase may be passed over a multifunctional catalyst. A hydrogen donor, ethanol, may be passed over the multifunctional catalyst along with the bio-oil vapor phase at a temperature of 550° C. A modified bio-oil in the vapor phase may be produced at the multifunctional catalyst. The modified bio-oil in the vapor phase may be condensed to produce the modified bio-oil in the liquid phase. The modified bio-oil may include reaction products of the bio-oil vapor phase and the ethanol. For example, the modified bio-oil may include fewer reactive radicals. The modified bio-oil may have improved properties compared to non-catalyzed bio-oil or bio-oil produced at a mono-functional catalyst, for example, higher heating value.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the terms “coupled” or “operatively connected” are used in the specification or the claims, it is intended to mean that the identified components are connected in a way to perform a designated function. To the extent that the term “substantially” is used in the specification or the claims, it is intended to mean that the identified components have the relation or qualities indicated with degree of error as would be acceptable in the subject industry.

As used in the specification and the claims, the singular forms “a,” “an,” and “the” include the plural unless the singular is expressly specified. For example, reference to “a compound” may include a mixture of two or more compounds, as well as a single compound.

As used herein, the term “about” in conjunction with a number is intended to include ±10% of the number. In other words, “about 10” may mean from 9 to 11.

As used herein, the terms “optional” and “optionally” mean that the subsequently described circumstance may or may not occur, so that the description includes instances where the circumstance occurs and instances where it does not.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

The various aspects and embodiments disclosed herein are for purposes of illustration and are not intended to be limiting, with the true scope and spirit being indicated by the following claims.

1. A method for producing a modified bio-oil, comprising:
providing a bio-oil vapor phase;
contacting the bio-oil vapor phase with a multifunctional catalyst under conditions effective to catalyze a plurality of distinct reactions on the bio-oil vapor phase to produce the modified bio-oil in the vapor phase, the plurality of distinct reactions comprising at least ketonization.

2. The method of claim 1, further comprising condensing the modified bio-oil from the vapor phase.

3. The method of claim 1, the modified bio-oil being characterized by one or more of:
a greater heating value compared to a liquid bio-oil condensed from the bio-oil vapor phase;
a heating value of at least about 20 MJ/mol;
a lower total acid number (TAN) compared to a liquid bio-oil condensed from the bio-oil vapor phase;
a total acid number (TAN) of less than about 100;
a lower oxygen content compared to a liquid bio-oil condensed from the bio-oil vapor phase;
an oxygen content based on wet liquid phase modified bio-oil of less than about 45% by weight;
an oxygen content based on dry liquid phase modified bio-oil of less than about 30% by weight;
compared to a liquid bio-oil condensed from the bio-oil vapor phase, by a greater content of one or more of: ketones, aldols, esters, ethers, and saturated compounds;
compared to a liquid bio-oil condensed from the bio-oil vapor phase, by a lower content of one or more radicals;
compared to a liquid bio-oil condensed from the bio-oil vapor phase, by a higher average molecular weight;
compared to a liquid bio-oil condensed from the bio-oil vapor phase, by a higher viscosity; and
compared to a liquid bio-oil condensed from the bio-oil vapor phase by a higher hydrogen to carbon ratio.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. The method of claim 1, the bio-oil vapor phase characterized by one or more of:
being at a pressure between about 1 atmospheres and about 35 atmospheres;
being at ambient pressure of about 1 atmosphere;
being at a temperature between about 300° C. and about 600° C.;
being at a temperature between about 450° C. and about 500° C.;
comprising one or more radicals, at least one of the plurality of distinct reactions being a catalyzed reaction of at least one of the one or more radicals; and
comprising one or more radicals, at least one of the plurality of distinct reactions comprising reacting at least one of the one or more radicals to form a closed-shell product compound.

16. (canceled)

17. (canceled)

18. (canceled)

19. (canceled)

20. (canceled)

21. The method of claim 1, the providing the bio-oil vapor phase comprising one or more of:
pyrolyzing a biomass;
pyrolyzing the biomass, the biomass comprising a water content by weight of between about 1% and about 25%;
pyrolyzing the biomass by heating the biomass at a heating rate effective to cause a vaporization in at least a portion of the biomass;
pyrolyzing the biomass, the biomass comprising one or more of: cellulose, hemicellulose, and lignin, the pyrolyzing the biomass comprising chemical dehydration of one or more of: the cellulose, hemicellulose, and lignin;
pyrolyzing the biomass comprising one or more of: chemical dehydration and decarboxylation to produce one or more radicals;
pyrolyzing a biomass at a temperature between about 400° C. and about 600° C.;
pyrolyzing a biomass at a temperature between about 450° C. and about 500° C.

22. (canceled)

23. (canceled)

24. (canceled)

25. (canceled)

26. (canceled)

27. (canceled)

28. The method of claim 1, the contacting the bio-oil vapor phase to the multifunctional catalyst being conducted in the presence of one or more non-condensable compounds.

29. The method of claim 28, at least one of the plurality of distinct reactions comprising reacting the bio-oil vapor phase with the one or more non-condensable compounds to produce the modified bio-oil.

30. The method of claim 28, at least one of the plurality of distinct reactions comprising a coupling reaction with the one or more non-condensable compounds to produce a coupled compound fraction, the coupled compound fraction being condensable under conditions effective to condense the modified bio-oil from the vapor phase.

31. The method of claim 28, the one or more non-condensable compounds comprising one or more of: carbon monoxide, carbon dioxide, hydrogen, and a C₁-C₆ hydrocarbon.

32. (canceled)

33. (canceled)

34. (canceled)

35. The method of claim 1, the contacting the bio-oil vapor phase to the multifunctional catalyst being conducted in the presence of one or more hydrogen donor compounds effective to increase a hydrogen to carbon ratio in the modified bio-oil compared to the absence of the one or more hydrogen donor compounds.

36. (canceled)

37. (canceled)

38. The method of claim 35, the one or more hydrogen donor compounds comprising one or more of: methanol, ethanol, 1-propanol, 2-propanol, 1-butanol, 2-butanol, sec-butyl alcohol, tert-butyl alcohol, and ethylene glycol.

39. The method of claim 1, the multifunctional catalyst:
comprising two or more of: a basic catalyst, an acidic catalyst, a ketone-forming catalyst, an aldol-forming catalyst, an esterification catalyst, an etherification catalyst, and a cracking catalyst;
comprising a transition metal oxide;
comprising one or more of: TiO₂, RuTiO₂, Cr/TiO₂, Ru/TiO₂, Pd/NbOx, and FCC catalyst;
comprising a zeolite;
comprising one or more of: Mg/Al₂O₃, WZrO, ZrO, TiO₂, ZSM5, and SiO₂;
comprising a combination of a noble metal and one or more of: Cu, Ni, Co, Mo, Pt, Pd, Re, Ru, and Rh;
comprising one or more of: Pt/MgAl₂O₃, Pt/Al₂O₃, Pd/ZSM4, and Pd/Al₂O₃; and comprising one or more of: a fluid cracking catalyst and a hydrocracking catalyst.

40. (canceled)

41. (canceled)

42. (canceled)

43. (canceled)

44. (canceled)

45. (canceled)

46. (canceled)

47. The method of claim 1, further comprising regenerating at least a portion of the multifunctional catalyst in air.

48. The method of claim 1, the plurality of distinct reactions further comprising one or more of: esterification, etherification, isomerization, cracking reactions, and deoxygenation.

49. A modified bio-oil, the modified bio-oil being prepared by reaction of a bio-oil vapor phase in the presence of a multifunctional catalyst under conditions effective to catalyze a plurality of distinct reactions on the bio-oil vapor phase.

50. (canceled)

51. The modified bio-oil of claim 49, being characterized by one or more of:
a greater heating value compared to a liquid bio-oil condensed from the bio-oil vapor phase;
a heating value of at least about 20 MJ/mol;
a lower total acid number (TAN) compared to a liquid bio-oil condensed from the bio-oil vapor phase;
a total acid number (TAN) of less than about 100;
a lower oxygen content compared to a liquid bio-oil condensed from the bio-oil vapor phase;
an oxygen content based on wet liquid phase modified bio-oil of less than about 45% by weight;
an oxygen content based on dry liquid phase modified bio-oil of less than about 30% by weight;
compared to a liquid bio-oil condensed from the bio-oil vapor phase, by a greater content of one or more of: ketones, aldols, esters, ethers, and saturated compounds;
compared to a liquid bio-oil condensed from the bio-oil vapor phase, by a lower content of one or more radicals;
compared to a liquid bio-oil condensed from the bio-oil vapor phase, by a higher average molecular weight;
compared to a liquid bio-oil condensed from the bio-oil vapor phase, by a higher viscosity; and
compared to a liquid bio-oil condensed from the bio-oil vapor phase by a higher hydrogen to carbon ratio.

52. (canceled)

53. (canceled)

54. (canceled)

55. (canceled)

56. (canceled)

57. (canceled)

58. (canceled)

59. (canceled)

60. (canceled)

61. (canceled)

62. The modified bio-oil of claim 49, comprising a coupled compound fraction, the coupled compound fraction being a reaction product of one or more non-condensable compounds.

63. The modified bio-oil of claim 62, the coupled compound fraction being a product of the one or more non-condensable compounds and the bio-oil vapor phase.

64. The modified bio-oil of claim 62, the one or more non-condensable compounds comprising one or more of: carbon monoxide, carbon dioxide, hydrogen, and a C₁-C₆ hydrocarbon.

65. (canceled)

66. (canceled)

67. (canceled)

68. (canceled)
